(19) United States
(12) Patent Application Publication
(10) Pub. No.: US 2022/0325688 A1
(43) Pub. Date: Oct. 13, 2022

(54) HYDROKINETIC ENERGY DEVICE

(71) Applicant: LITTORAL POWER SYSTEMS, INC., New Bedford, MA (US)

(72) Inventors: David J. Duquette, Fairhaven, MA (US); Kimbal Anderson Hall, Princeton, MA (US)

(21) Appl. No.: 17/842,468

(22) Filed: Jun. 16, 2022

Related U.S. Application Data
(63) Continuation-in-part of application No. 16/566,503, filed on Sep. 10, 2019, now Pat. No. 11,371,481.
(60) Provisional application No. 62/729,668, filed on Sep. 11, 2018.

(51) Int. Cl. F03B 3/12; F03B 11/06; F03B 11/02; H02K 7/18

(52) U.S. Cl. CPC F03B 3/121; F03B 11/06; F03B 11/02; H02K 7/1823; F05B 2240/917; F05B 2260/90; F05B 2220/706

(57) ABSTRACT

Systems and method for a hydrokinetic energy device. A hydrokinetic energy device includes a main body including two main wing-shaped spars mounted upon a rotating central hub, and rotatable spar tip turbines mounted at or near an end of each of the main wing-shaped spars, the main wing-shaped spars driving the rotatable spar tip turbines through water, each of the rotatable spar tip turbines including a direct-drive generator and power conversion system that transfers power from a rotating rotatable spar tip turbine to the central hub where the voltage is stepped up and amperage is reduced.

### CROSS-REFERENCE TO RELATED APPLICATIONS

This application is a Continuation-In-Part (CIP) of U.S. patent application Ser. No. 16/566,503, filed Sep. 10, 2019, which claims benefit from U.S. Provisional Patent Application Ser. No. 62/729,668, filed Sep. 11, 2018, which is incorporated by reference in its entirety.

### STATEMENT REGARDING GOVERNMENT INTEREST

This invention was made with government support under DE-EE0008628 awarded by the Department of Energy. The government has certain rights in the invention.

### FIELD OF THE INVENTION

The invention generally relates energy devices, and more specifically to a hydrokinetic energy device.

### BACKGROUND OF THE INVENTION

In general, hydrokinetic devices are powered by moving water and are different from traditional hydropower turbines in that they are placed directly in a river, ocean or tidal current. They generate power only from the kinetic energy of moving water (current). This power is a function of the density of the water and the speed of the current cubed. The available hydrokinetic power depends on the speed of the river, ocean, or tidal current. In order to operate, hydrokinetic devices require a minimum current and water depth. As water flows through a turbine or other device, the kinetic energy of the flowing river, tidal fluctuations, or waves is converted into electricity by the device.

The minimum current required to operate a hydrokinetic device is typically 2-4 knots. Optimum currents are in the 5-7 knot range. Water depth is an important factor in the total energy that can be extracted from a site, since rotor diameter is dependent on adequate water level above the installed device. Hydrokinetic devices are ideally installed in locations with relatively steady flow throughout the year, locations not prone to serious flood events, turbulence, or extended periods of low water level.

### BRIEF SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a hydrokinetic energy device including a main body including two main wing-shaped spars mounted upon a rotating central hub, and rotatable spar tip turbines mounted at or near an end of each of the main wing-shaped spars, the main wing-shaped spars driving the rotatable spar tip turbines through water, each of the rotatable spar tip turbines including a direct-drive generator and power conversion system that transfers power from a rotating rotatable spar tip turbine to the central hub where the voltage is stepped up and amperage is reduced.

In another aspect, the invention features a method including providing a hydrokinetic energy device, the hydrokinetic energy device including a main body having a tether and two main wing-shaped spars mounted upon a rotating central hub, and rotatable spar tip turbines mounted at or near an end of each of the main wing-shaped spars, the main wing-shaped spars driving the rotatable spar tip turbines through water, each of the rotatable spar tip turbines including a direct-drive generator and power conversion system that transfers power from a rotating rotatable spar tip turbine to the central hub where the voltage is stepped up and amperage is reduced, attaching an anchor to the tether, dropping the anchor into a body of water, and floating the tether in a water column with a submersed buoy.

In still another aspect, the invention features a method including providing a hydrokinetic energy device, the hydrokinetic energy device including a main body having two main wing-shaped spars mounted upon a rotating central hub, and rotatable spar tip turbines mounted at or near an end of each of the main wing-shaped spars, the main wing-shaped spars driving the rotatable spar tip turbines through water, each of the rotatable spar tip turbines including a direct-drive generator and power conversion system that transfers power from a rotating rotatable spar tip turbine to the central hub where the voltage is stepped up and amperage is reduced, providing an unmanned underwater vehicle, linking the hydrokinetic energy device to the unmanned underwater vehicle, and deploying the hydrokinetic energy device.

In one embodiment is a hydrokinetic energy device having a main body including at least one wing-shaped spar mounted upon a rotating central hub, and a rotatable spar tip turbine blade mounted at or near an end of the at least one wing-shaped spar, where the at least one wing-shaped spar is configured to drive the rotatable spar tip turbine blade through water. In this embodiment, the rotatable spar tip turbine includes a blade having a rotatable spar tip turbine blade length where a width of the rotatable spar tip turbine blade at eighty percent of the rotatable spar tip turbine blade length is more than half a width of the rotatable spar tip turbine blade length at its widest point near a base of the rotatable spar tip turbine blade length.

In one embodiment, the rotatable spar tip turbine includes a direct-drive generator that transfers power from the rotating rotatable spar tip turbine to the central hub. In another embodiment, within the central hub the voltage is stepped up and amperage is reduced.

In one embodiment, the main body of the hydrokinetic energy device further includes a tether, a front nacelle, a braking system to slow the rotatable spar tip turbine when brought to a water surface and to prevent over-speed during times when power output is too high, a sealing system, and a front casing.

In one embodiment, the tether is configured for mooring and housing an electrical cable. In another embodiment, the main body of the hydrokinetic device also includes a rear casing, a bearing, and a rear nacelle.

In one embodiment, the rotatable spar tip turbine of the hydrokinetic energy device further includes a rear nacelle, a sealing system, a rear casing, a three-bladed propeller, a front casing, a bearing, and a front nacelle.

In one embodiment, the wing-shaped spar is constructed from a composite material.

In one embodiment, a hydrokinetic energy device includes a main body having at least one wing-shaped spar mounted upon a rotating central hub, and a rotatable spar tip turbine blade mounted at or near an end of the at least one wing-shaped spar, the at least one wing-shaped spar driving the rotatable spar tip turbine blade through water.

In this embodiment, the rotatable spar tip turbine includes a blade having a rotatable spar tip turbine blade length where a width of the rotatable spar tip turbine blade at eighty percent of the rotatable spar tip turbine blade length is more than half a width of the rotatable spar tip turbine blade length at its widest point near a base of the rotatable spar tip turbine blade length.

In this embodiment, the rotatable spar tip turbine includes a direct-drive generator that transfers power from the rotating rotatable spar tip turbine to the central hub where a voltage is stepped up and amperage is reduced.

In one embodiment, a hydrokinetic energy device includes a main body having at least one wing-shaped spar mounted upon a rotating central hub, a tether, a front nacelle, a sealing system, a front casing, a rear casing, a bearing, and a rear nacelle, and a rotatable spar tip turbine blade mounted at or near an end of the at least one wing-shaped spar.

In this embodiment, the rotatable spar tip turbine blade has a rotatable spar tip turbine blade length where a width of the rotatable spar tip turbine blade at eighty percent of the rotatable spar tip turbine blade length is more than half a width of the rotatable spar tip turbine blade length at its widest point near a base of the rotatable spar tip turbine blade length.

In one embodiment, the rotatable spar tip turbine blade further includes a direct-drive generator that transfers power from the rotating rotatable spar tip turbine blade to the central hub where a voltage is stepped up and an amperage is reduced.

In another embodiment, the rotatable spar tip turbine blade also includes a rear nacelle, a sealing system, a rear casing, a three-bladed propeller, a front casing, a bearing, a braking system to slow the rotatable spar tip turbine when brought to a water surface and to prevent over-speed during times when power output is too high, and a front nacelle.

In one embodiment, the tether of the hydrokinetic energy device is configured for mooring and housing an electrical cable.

In another embodiment, the wing-shaped spar of the hydrokinetic energy device is constructed from a composite material.

Embodiments of the invention may have one or more of the following advantages.

The system of the present invention produces meaningful power even in marginal current velocities.

The system of the present invention can be installed and maintained safely and cost officially while little impact on navigation through the use of self-deploying devices.

Turbine assemblies of the present invention are attached to a single point mooring line and anchor that can reduce deployment costs and interference with surface navigation, as compared to traditional approaches requiring structural pilings or bedrock mounted frames and maintenance via on station surface vessels.

The system of the present invention and its components address the nascent marine hydrokinetic energy industry's cost-reduction needs and reduce barriers to deployment with technology rather than relying on long, drawn-out policy changes or hoped for easing of hydropower regulations.

### BRIEF DESCRIPTION OF THE DRAWINGS

These and other features, aspects, and advantages of the present invention will become better understood with reference to the following description, appended claims, and accompanying drawings where:

FIG. 1 is an illustration of an exemplary hydrokinetic energy device.

FIG. 2 is another illustration of the exemplary hydrokinetic energy device.

FIG. 3 is an illustration of a front view of the two main wing-shaped spars mounted upon the rotating center hub with two rotatable spar tip turbines.

FIG. 4 is an illustration of a top view of the hydrokinetic energy device.

FIG. 5 is an illustration of a front view of the rotatable spar tip turbine.

FIG. 6A illustrates a cross-sectional view of the rotatable spar tip turbine taken along the line 6-6 of FIG. 5.

FIG. 6B illustrates an exemplary of a tip turbine.

FIG. 6C illustrates a tip turbine blade.

FIG. 7A is a graph.

FIG. 7B is another graph.

FIG. 8 illustrates an exemplary baseline electrical system for the hydrokinetic energy device.

FIG. 9 illustrates an exemplary an unmanned underwater vehicle (UUV) deployment of a hydrokinetic energy device.

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

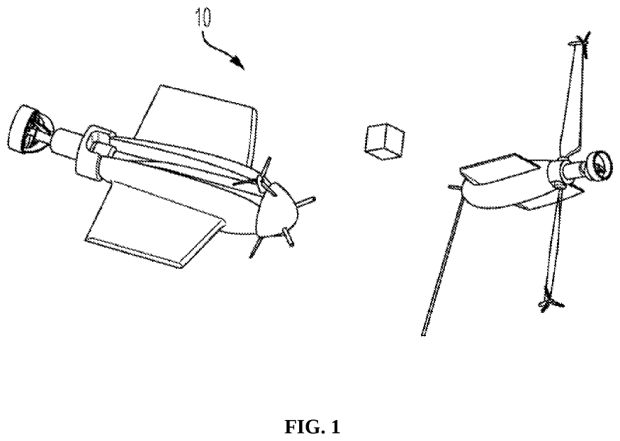

As shown in FIG. 1, an exemplary hydrokinetic energy device 10 of the present invention (with wing-shaped spars folded (left), with wing-shaped spars deployed (right)) features a turbine with capability to harness significant power from the moderate flows a water resources within the United States. The hydrokinetic energy device 10 can be manually deployed and tethered, but is more likely to be used in semi-autonomous or remote operated mode to avoid having a vessel in a navigation channel. For this same reason, the hydrokinetic energy device 10 includes an anchored tether for the mooring and electrical cable that can be quickly dropped in place off a barge.

The hydrokinetic energy device 10 folds into a streamlined body. Its ballast tanks are flooded to provide neutral buoyancy and the hydrokinetic energy device 10 is launched from shore, or from a vessel position alongside the navigable channel. The hydrokinetic energy device 10 swims out to a specified mooring tether, using electric propeller drive machinery. The hydrokinetic energy device 10 trails a surface communication pack. The hydrokinetic energy device 10 uses acoustics to home in on its tether. With its streamlined shape one can estimate that the hydrokinetic energy device 10 can swim a quarter mile in a 6-knot current with enough on-board battery power to last 30 minutes. Thus, the hydrokinetic energy device 10 is for a semi-autonomous central nacelle that can transport and deploy itself onto a power head of a free-flying submerged tether, obviating human intervention.

Tethers are floated up in the water column buy submersible buoys. An upper end of the tether is attached to a structural and electrical coupling for the hydrokinetic energy device 10. As the hydrokinetic energy device 10 swims in, it catches its tether using a whisker wire and makes its mechanical connection by sliding up to the top of the tether wire.

The hydrokinetic energy device 10 is designed to achieve commercially attractive leveled cost of energy (LCOE) in slow-moving currents with a three-pronged approach:
1. The hydrokinetic energy device 10 trades swept area for velocity to take advantage of the fact that in a lift device, developed power varies as a cubic function of velocity and only as a linear function of swept area. In the hydrokinetic energy device 10, very low-cost, lightweight, direct-drive generators and turbines are placed at or near the ends of driving wing-shaped spars that drive them through the water at up to six times faster than the free stream velocity.
2. The small inexpensive wing-shaped spar-rotatable spar tip turbines are placed downstream of the driving wing-shaped spar tip such that the driving wing-shaped spar's shed wingtip vortex, i.e., a significant swirl created at the end of the blades, enhances the power generation. The spar tip turbines may be placed on the end of the spars, however the spar tip vortices rotate really fast and unpredictably at the core of the vortex and not as fast and are more predictable and uniform farther away from the core so positioning the spar tip turbines somewhat below the end of the spar tips or making the hub of the spar tip turbines sufficiently large will condition the vortex so it effectively interacts with the blades of the spar tip turbines. Another reason for an embodiment that positions the tip turbines below the end of the spar tips is to hide the tip turbine blades behind the main spars to minimize interaction with fish. Shrouding the tip turbine blades is another design approach to minimize fish interactions.
3. The configuration results in near zero net torque about the central axis of the hydrokinetic energy device 10. This gives rise to multiple benefits, among them that: (i) the driving wing-shaped spars can begin turning at very low velocities and start generating energy, and (ii) the device can be secured with simple low-cost moorings.

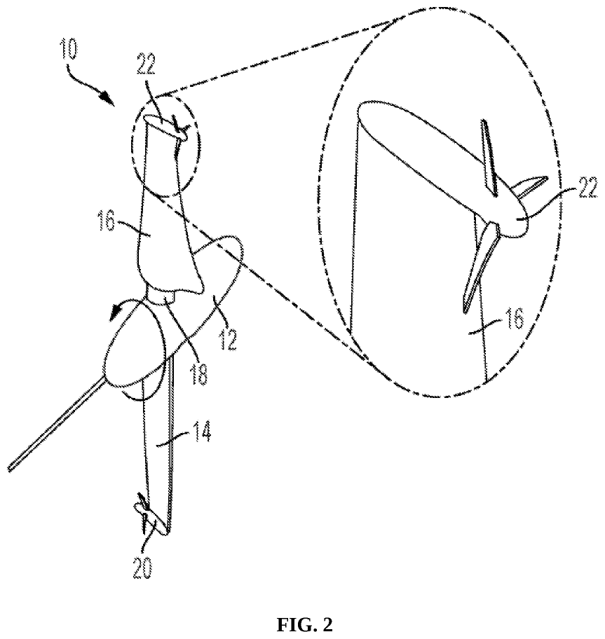

As shown in FIG. 2, the hydrokinetic energy device 10 includes a main body 12 with two main wing-shaped spars 14, 16 mounted upon a rotating center hub 18, with two rotatable spar tip turbines 20, 22 mounted at or near an end of each wing-shaped spar 14, 16, respectively. The main wing-shaped spars 14, 16 drive the rotatable spar tip turbines 20, 22 through the water but do not directly produce electrical power. Electrical power is taken out of the rotatable spar tip turbine rotors 20, 22 through a direct-drive generator and power conversion system (not shown), transported through cables running inside the main wing-shaped spars 14, 16, and is passed across the central hub 18 using a transformer (not shown). Electricity needs to be transported across a moving (rotating) interface that rotates with very little torque to get the electricity from the device into cables that carry it to shore. Slip rings can be used to transmit the electrical power across the rotation at the center of the hub of the driving spars, but a rotating transformer is more eloquent since no further downstream transformers are needed. Voltage is stepped up right in the hydrokinetic energy device 10, amperage is reduced, and no further “downstream” transformers are needed, saving on the cost of power cables.

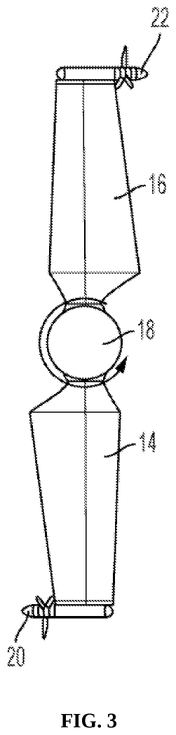

In FIG. 3, a front view illustrates the two main wing-shaped spars 14, 16 mounted upon the rotating center hub 18, with two rotatable spar tip turbines 20, 22 mounted at or near an end of each wing-shaped spars 14, 16, respectively.

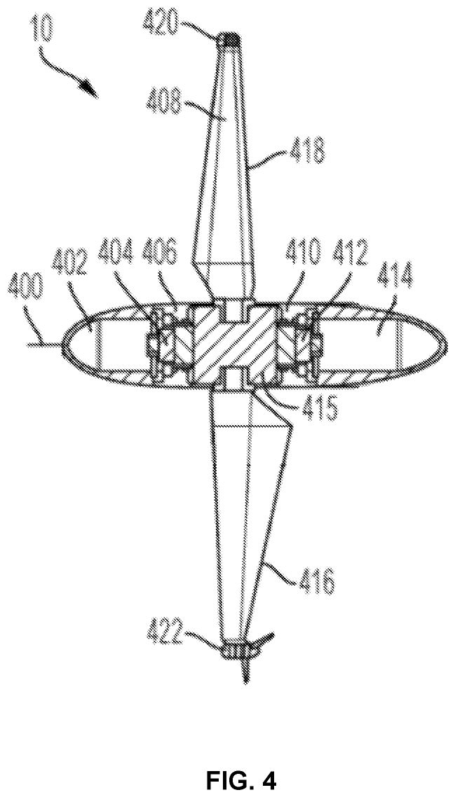

In FIG. 4, a top view of the hydrokinetic energy device 10 is illustrated and includes a tether 400, a front nacelle 402, a sealing system 404, a front casing 406 and first wing-shaped spar 408. The hydrokinetic energy device 10 includes a rear casing 410, a bearing 412, a rear nacelle 414, a hub 415 and a second wing-shaped spar 416. The first wing-shaped spar 408 is generally constructed from a composite material and includes an electrical connection 418 to a first rotatable spar tip turbine 420. The second wing-shaped spar 416 also includes an electrical connection (not shown) to a second rotatable spar tip turbine 422.

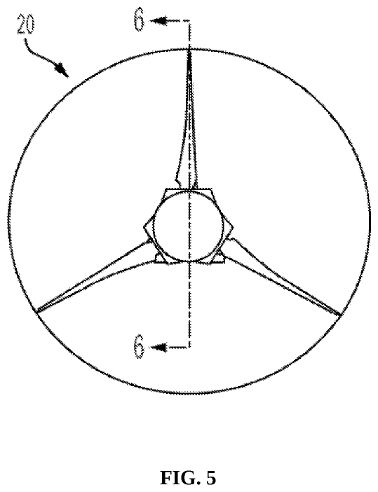

In FIG. 5, a front view of the rotatable spar tip turbine 20 is illustrated.

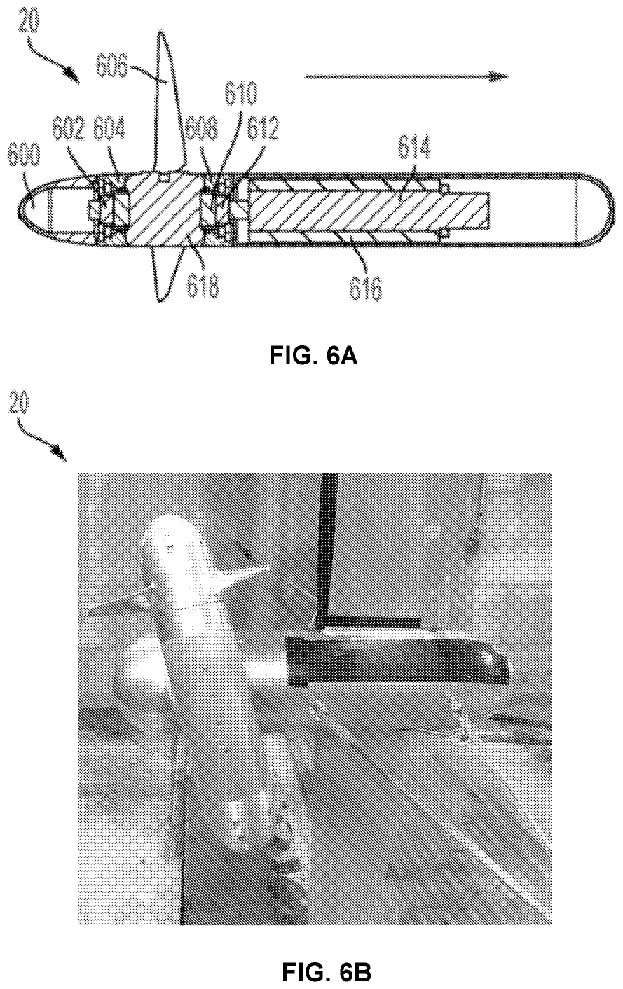

In FIG. 6A, a cross-sectional view of the rotatable spar tip turbine 20 as taken along the arrow line 6-6 of FIG. 5. As illustrated, the rotatable spar tip turbine 20 includes a rear nacelle 600, a sealing system 602, a rear casing 604, a three-bladed propeller 606, a front casing 608, a bearing 610, a braking system 612, a front nacelle 614, a generator 616 and a hub 618. While the above discussion focused on the various elements of the rotatable spar tip turbine 20, it is understood that the same elements may be equally applicable to the other turbines 22, 420, 422 as can be appreciated by one skilled in the art.

In one embodiment, a braking system 612 is required to keep the turbine 20 from spinning during deployment and maintenance. In typical axial turbine configurations that are attached to rigid supports, the support is able to counteract the torque from the turbine to keep it from spinning. However, a low torque mooring system prevents such a technique from being used for this device 10. Instead, hydrodynamic torque from the wing-shaped spars 14 must be neutralized to prevent the turbine 20 from spinning. Torque-neutralization can be accomplished in a number of ways, including: pitch control of the wing-shaped spars 14, where the entire wing-shaped spar 14 feathers into the current; rotating the outer portion of the wing-shaped spars 14 while maintaining the pitch of the root of the wing-shaped spars 14; folding the wing-shaped spars 14 either upstream or downstream so that the axis of the wing-shaped spars 14 is aligned with the direction of the current; or slowing the turbine 20 by opening a flow passage from the root of the wing-shaped spar 14 to the tip of the wing-shaped spar 14 that would centrifugally pump water from the root to the tip when the wing-shaped spar 14 is spinning, thereby slowing the rotational speed of the turbine 20. The latter method would be used only to slow the turbine 20 so that it might be brought up to the surface, and having the turbine 20 lay on the surface would prevent rotation. Several of these braking techniques can also be used to prevent over-speed during times when power output is too high, or current speeds are high enough that they may cause damage to the device if it were to continue with normal operation.

While the above discussion focused on a braking system 612 and braking techniques and methods for the rotatable spar tip turbine 20, it is understood that a similar braking system, techniques and methods may be equally applicable to the other turbines 22, 420, 422 as can be appreciated by one skilled in the art.

In one embodiment, the tip turbines 20, 22 are axial turbines. A typical blade on an axial turbine has a shape and angle of attack that is optimized to provide the maximum amount of power for a given swept area. Indeed, the power coefficient is defined as this ratio. Maximizing power for swept area is associated with large thrust loading, i.e., axial force on the turbine. High thrust loads on the tip turbines will slow down the rotational speed of the wing-shaped spars 14, 16 on the main body 12 that are driving the tip turbines 20, 22, which means the tip turbines 20, 22 will be traveling through the water at a slower speed and will generator less power—a lot less power since all things being equal, the power generated varies with the cube of the speed of the water flowing past a turbine. In the present invention, maximum hydraulic power will be generated by optimizing the shape and angle of attack of the tip turbine blades and the shaft speed for the tip turbines to maximize the power-to-thrust ratio. In other words, to maximize the amount of power for a given amount of thrust. An optimally efficient tip turbine 20, 22 will have a larger diameter and spin slower than a typical high performing axial turbine. These conditions result in lower shaft speeds and steeper pitch on the tip turbine blades than for an optimal typical axial turbine.

For example, assume an ideal Betz limit turbine is used for the tip turbine, with a power coefficient right at the Betz limit of 0.593. This Betz turbine would also inherently have a thrust coefficient of 8/9, or 0.889. Although the power coefficient is as high as is physically possible, the power-to-thrust ratio is only 0.667. In contrast, the tip turbines 20, 22 have larger diameter, spin slower and have blades pitched so that the lift from the airfoils is acting more in the direction of torque than in the direction of thrust loading as compared to the Betz turbine. As a result, in one specific embodiment shown in FIG. 6B, tip turbines 20, 22 have a low power coefficient of only 0.157; however, the thrust coefficient is also very low at 0.168 yielding a power-to-thrust ratio of 0.934, which is much higher than the Betz turbine power-to-thrust ratio of 0.667. In this embodiment, the maximum power for tip turbines 20, 22 is achieved at a tip turbine tip speed ratio in a range of from about 1 to about 3, and more preferably, at about 2.

The characteristic shape of the tip turbine 20, 22 blades 606 viewed in cross section from the perspective shown in FIGS. 6A-6B, where the axis of the tip turbine 20, 22 is 14 degrees from being perpendicular to the rotation axis of the hydrokinetic device 10, is magnified in FIG. 6C. A typical axial turbine blade 606 viewed from this perspective would have a very thin outer part near the tip as the view would show primarily the thickness of the blade, and not any chord length because the airfoil shape would be rotated nearly perpendicular to the direction the tip turbine nacelle is travelling through the water due to the high tip speed ratio.

As shown in FIG. 6C, this contrasts with applicant's tip turbine blade. More specifically, as shown in FIG. 6C, label 650 represents 100% of a tip turbine blade length, label 655 represents 80% of the tip turbine blade length and label 660 represents a root of the tip turbine blade, i.e., 0% of the tip turbine blade length. Here, a width 665 of the tip turbine blade at 80% of the tip turbine blade length 650 is more than half a width 670 of the tip turbine blade at its widest point near the root 660 of the tip turbine blade length. This shape from this perspective indicates blades 606 are more axially aligned with the flow than a typical axial flow turbine and that the tip turbines 20, 22 are designed for a lower tip speed ratio.

While the above discussion focused on blades 606 for tip turbines 20, 22, it is understood that similar blade systems may be equally applicable to the other turbines 420, 422 as can be appreciated by one skilled in the art.

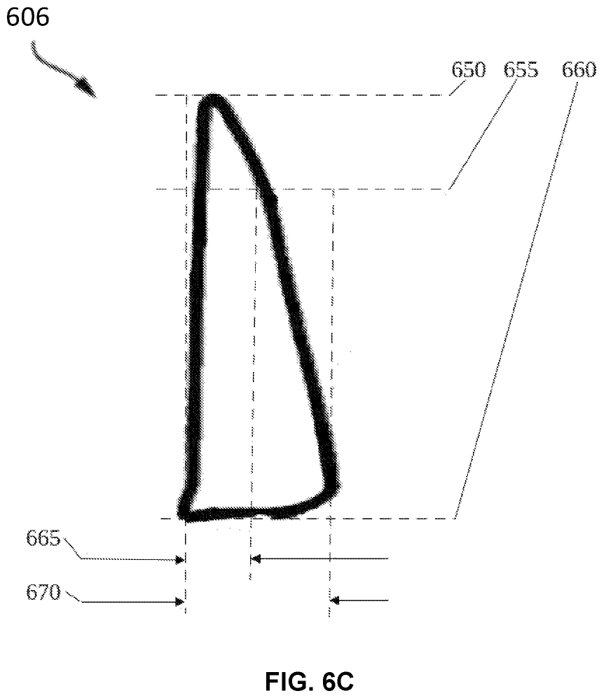

In FIG. 7A, a graph 300 illustrates mechanical power produced by a 7.75 m turbine in a 4-knot current as a function of the tip speed ratio for the driving wing-shaped spars and the tip speed ratio of the rotatable spar tip turbine rotors, with and without an effect of the vortex.

In FIG. 7B, a graph 310 illustrates the optimal size of the rotatable spar tip turbine decreases as the driving wing-shaped spar tip speed ratio increases.

The graphs 300 and 310 show that by placing the rotatable spar tip turbines immediately downstream of the end of the driving wing-shaped spars in order to capture additional energy from the wingtip shed vortices, the turbine power output can be increased by approximately 40% compared with placing the turbines in undisturbed flow at the leading edge of the main rotor. Testing of the embodiment as shown in FIG. 6B with the tip turbines oriented with the turbine rotor aft of the driving spars demonstrated a 17% increase in turbine power output compared to the power output when the tip turbines were oriented with the rotor leading the driving spars.

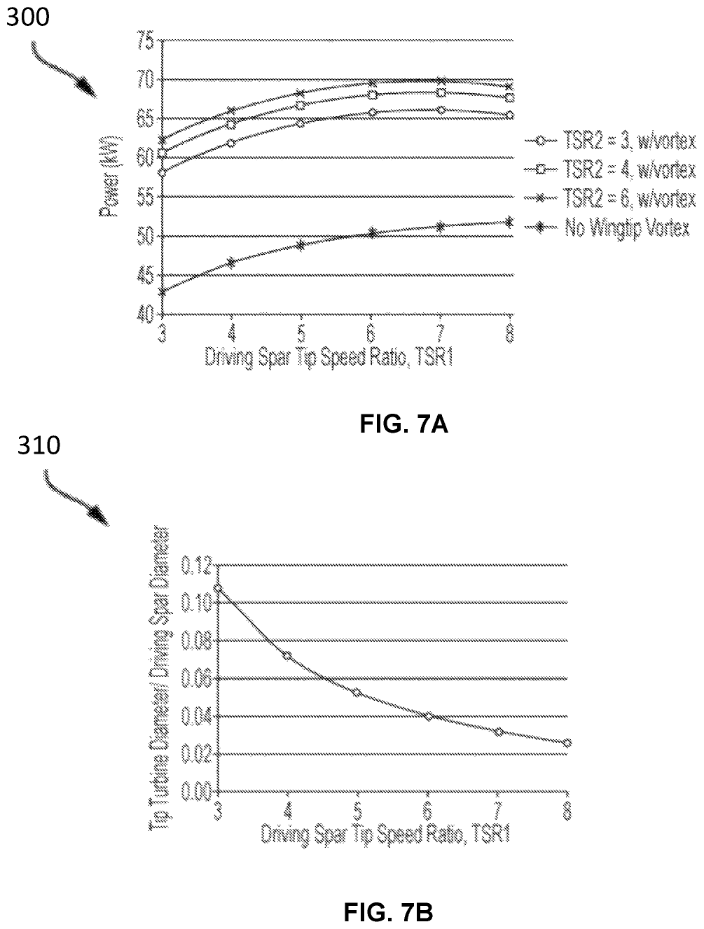

In FIG. 8, an exemplary baseline electrical system 800 for the hydrokinetic energy device 10 is shown. A bridge converter excites the primary of the rotating transformer. The secondary of the rotating transformer feeds an uncontrolled rectifier, delivering energy to a second DC bus. Energy delivered to the second DC bus is inverted into the AC grid. There are at least three possible places to combine the outputs of the generators: (i) the first DC bus; (ii) the second DC bus; and (iii) the grid itself.

Converter topology decisions are made in the context of supporting turbine operation and control at all times while trying to minimize LCOE. For example, using a fully controlled inverter to interface the generator to the first DC bus allows full control over generator phase currents. This topology improves generator efficiency and power factor, but perhaps more importantly enables the rotatable spar tip turbines to be deferentially loaded. This is highly valuable for overall turbine operation, particularly in shallow water, and justifies possible additional cost and complexity.

It is anticipated the power conversion system from the generator through the primary of the rotating transformer will be packaged within the driving wing-shaped spars to take advantage of the significant surface area available for heat rejection. The electrical conversion system is encapsulated from the generator stator windings through the grid converter. The secondaries of the rotating transformers and grid interface converter are packaged within the tethered nacelle of the turbine.

The generator is a permanent magnet machine with high pole count. For a rotatable spar tip turbine rotational speed of 625 rpm for a 0.75 m diameter rotatable spar tip turbine, the fundamental electrical frequency generated is 5.208 Nₚ, where Nₚ is the number of poles in the generator. Targeting a fundamental frequency of approximately 200 Hz, Nₚ is in the range of 38. A fundamental frequency of 200 Hz for a three-phase generator when rectified converts to a fundamental ripple frequency of 1200 Hz at the DC bus, keeping the filtering requirements quite modest. The high pole count keeps the flux per pole low, requiring thin back iron in the stator and making the generator rim-like in nature, suitable for packaging within a shroud that protects the turbine. The baseline generator has the stator on the inside and is a radial field configuration. Generator power density is aided through immersion in water.

The rotary transformer uses radial or axial magnetic fields. The high- and low-voltage windings rotate relative to one another without changing the magnetic circuit; hence, power transfer is independent of relative rotational motion. While there are design challenges, the rotating transformer represents a robust, low-maintenance component with high reliability and modest cost, a significant alternative to traditional slip rings. Further, the turns ratio of the rotating transformer provides a degree of freedom in optimizing the electrical system design.

The design of the hydrokinetic energy device 10 gives rise to a number of simple, inexpensive deployment techniques. More specifically, the hydrokinetic energy device 10 can be quickly and easily deployed with a variety of mooring systems depending on the site characteristics. There are two principal reasons for this ease of deployment. First, the lack of any appreciable torque reaction about the central axis of the hydrokinetic energy device 10 permits mooring on a single tether as no or minimal rotational force needs to be resisted in order to hold it on station. Second, the hydrokinetic energy device 10 is compact and lightweight; as such, only a simple inexpensive work boat or barge with a small crane is required for deployment and retrieval as there is little danger of capsizing when the hydrokinetic energy device 10 is lowered over the side. This approach obviates the need for a specialized, expensive-to-charter ship containing a “moon pool.” With added buoyancy and/or lifting winglets, the hydrokinetic energy device 10 can be floated up into the highest-current-velocity region of the water column.

Rapid deployment is critical in utility-scale projects that are deployed underneath surface traffic. In these cases, deploying the hydrokinetic energy device 10 starts with using a gravity base and/or anchor to which is attached a tether containing an electrical cable that can be quickly dropped in place off a barge. A single electromechanical cable for load bearing as well as power/data transmission is a commercially available off-the-shelf (COTS) part. The tether is floated up in the water column via a submersed buoy, onto which the hydrokinetic energy device 10 is mechanically and electrically connected.

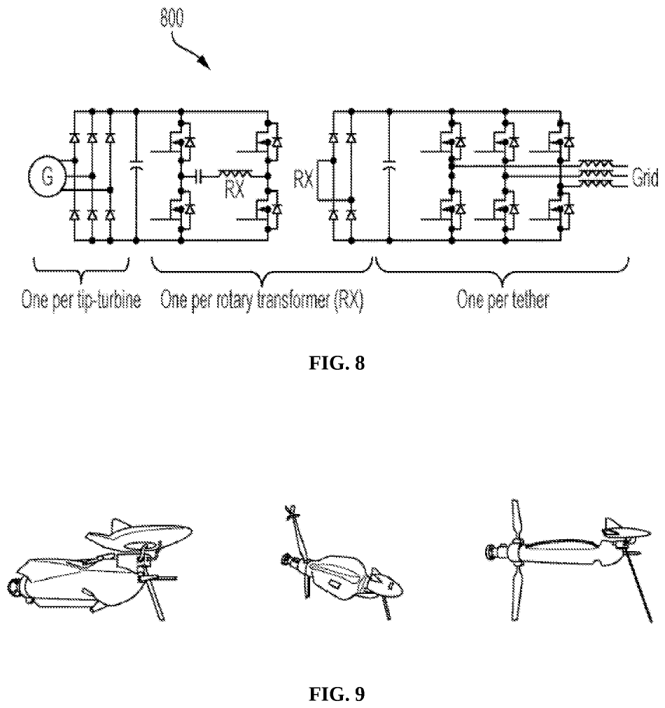

As shown in FIG. 9, the hydrokinetic energy device 10 can be part of an unmanned underwater vehicle (UUV) deployment, whether remote, semi-autonomous or autonomous, to solve the key problem of access in heavily navigated waterways. Many of the more favorable in current hydrokinetic sites are found underneath navigation channels, because currents tend to run fastest in deep water channels. For example, the lower Mississippi River offers the opportunity to sweep large areas of low-to-medium-velocity current and is near ample power distribution resources on shore. However, surface traffic is extremely busy in this area: over 200 vessels of 300′ or greater in overall length transit New Orleans daily. As such, the navigation channel must be kept open at all times.

In one UUV deployment scenario, the hydrokinetic energy device 10 folds into a streamlined body with wings. The hydrokinetic energy device 10 is launched from a vessel positioned alongside the navigable channel. The hydrokinetic energy device 10 “swims” out to a specified mooring tether, using electric propeller drive machinery. The hydrokinetic energy device 10 trails a surface communication pack to provide radio communication and coarse navigation capabilities. To finally locate its tether, the hydrokinetic energy device 10 uses acoustic homing. As the hydrokinetic energy device 10 navigates to its designated power head, it catches the tether using a whisker wire and continues to swim over-center, and makes its mechanical connection as it slides up to the top of the tether wire. The electrical connection to the turbine is made with connectors as are commonly used to recharge many common UUVs.

Although FIG. 9 shows the UUV integral to one hydrokinetic energy device 10, in other implementations the UUV can be detachable so that it may deploy/serve multiple hydrokinetic energy devices for lower capital costs.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A hydrokinetic energy device comprising:
a main body comprising at least one wing-shaped spar mounted upon a rotating central hub; and
a rotatable spar tip turbine blade mounted at or near an end of the at least one wing-shaped spar, the at least one wing-shaped spar driving the rotatable spar tip turbine blade through water,
the rotatable spar tip turbine having a blade having a rotatable spar tip turbine blade length wherein a width of the rotatable spar tip turbine blade at eighty percent of the rotatable spar tip turbine blade length is more than half a width of the rotatable spar tip turbine blade length at its widest point near a base of the rotatable spar tip turbine blade length.

2. The hydrokinetic energy device of claim 1, wherein the rotatable spar tip turbine includes a direct-drive generator that transfers power from the rotating rotatable spar tip turbine to the central hub.

3. The hydrokinetic energy device of claim 2, wherein within the central hub the voltage is stepped up and amperage is reduced.

4. The hydrokinetic energy device of claim 1, wherein the main body further comprises:
a tether;
a front nacelle;
a braking system to slow the rotatable spar tip turbine when brought to a water surface and to prevent over-speed during times when power output is too high;
a sealing system; and
a front casing.

5. The hydrokinetic energy device of claim 4, wherein the tether is configured for mooring and housing an electrical cable.

6. The hydrokinetic energy device of claim 4, wherein the main body further comprises:
a rear casing;
a bearing; and
a rear nacelle.

7. The hydrokinetic energy device of claim 1, wherein the rotatable spar tip turbine further comprises:
a rear nacelle;
a sealing system;
a rear casing;
a three-bladed propeller;
a front casing;
a bearing; and
a front nacelle.

8. The hydrokinetic energy device of claim 1, wherein the wing-shaped spar is constructed from a composite material.

9. A hydrokinetic energy device comprising:
a main body comprising at least one wing-shaped spar mounted upon a rotating central hub; and
a rotatable spar tip turbine blade mounted at or near an end of the at least one wing-shaped spar, the at least one wing-shaped spar driving the rotatable spar tip turbine blade through water,
the rotatable spar tip turbine having a blade having a rotatable spar tip turbine blade length wherein a width of the rotatable spar tip turbine blade at eighty percent of the rotatable spar tip turbine blade length is more than half a width of the rotatable spar tip turbine blade length at its widest point near a base of the rotatable spar tip turbine blade length,
the rotatable spar tip turbine including a direct-drive generator that transfers power from the rotating rotatable spar tip turbine to the central hub where a voltage is stepped up and amperage is reduced.

10. The hydrokinetic energy device of claim 9, wherein the main body further comprises:
a tether;
a front nacelle;
a braking system to slow the rotatable spar tip turbine when brought to a water surface and to prevent over-speed during times when power output is too high;
a sealing system; and
a front casing.

11. The hydrokinetic energy device of claim 10, wherein the tether is configured for mooring and housing an electrical cable.

12. The hydrokinetic energy device of claim 10, wherein the main body further comprises:
a rear casing;
a bearing; and
a rear nacelle.

13. The hydrokinetic energy device of claim 9, wherein the rotatable spar tip turbine further comprises:
a rear nacelle;
a sealing system;
a rear casing;
a three-bladed propeller;
a front casing;
a bearing; and
a front nacelle.

14. The hydrokinetic energy device of claim 9, wherein the wing-shaped spar is constructed from a composite material.

15. A hydrokinetic energy device comprising:
a main body comprising:
at least one wing-shaped spar mounted upon a rotating central hub;
a tether;
a front nacelle;
a sealing system;
a front casing;
a rear casing;
a bearing; and
a rear nacelle; and
a rotatable spar tip turbine blade mounted at or near an end of the at least one wing-shaped spar, the rotatable spar tip turbine blade having a rotatable spar tip turbine blade length wherein a width of the rotatable spar tip turbine blade at eighty percent of the rotatable spar tip turbine blade length is more than half a width of the rotatable spar tip turbine blade length at its widest point near a base of the rotatable spar tip turbine blade length, the rotatable spar tip turbine blade comprising:
a direct-drive generator that transfers power from the rotating rotatable spar tip turbine blade to the central hub where a voltage is stepped up and an amperage is reduced;
a rear nacelle;
a sealing system;
a rear casing;
a three-bladed propeller;
a front casing;
a bearing;
a braking system to slow the rotatable spar tip turbine when brought to a water surface and to prevent over-speed during times when power output is too high; and
a front nacelle.

16. The hydrokinetic energy device of claim 15, wherein the tether is configured for mooring and housing an electrical cable.

17. The hydrokinetic energy device of claim 15, wherein the wing-shaped spar is constructed from a composite material.
